(19) United States
(12) Patent Application Publication
(10) Pub. No.: US 2002/0036959 A1
(43) Pub. Date: Mar. 28, 2002

(54) CD-RW drive with multi-stage linear velocities and different recording speeds and recording powers for each stage

(76) Inventors: Meng-Shin Yen, Taipei City (TW); William Wai Wang, Tao-Yuan City (TW); Tso-Tsai Chen, Taipei City (TW); Chi-Hung Chen, Tao-Yuan Hsien (TW)

Correspondence Address: WINSTON HSU, SF. 389, FU-HO ROAD, YUNGHO CITY, TAIPEI, TW

(21) Appl. No.: 09/682,570

(22) Filed: Sep. 21, 2001

(30) Foreign Application Priority Data
Sep. 22, 2000 (TW) 089119599

(51) Int. Cl. G11B 7/00

(52) U.S. Cl. 369/47.4; 369/47.51

(57) ABSTRACT

An optical storage carrier drive has a rotative mechanism for rotating an optical storage carrier, and a data access device for recording data to a track on the optical storage carrier. The track contains data units. The speed of each data unit passing by the data access device is termed the linear velocity. The method involves building a look-up table that divides the data units on the track into at least two sequentially arranged data blocks, and giving each data unit a different linear velocity to reduce the acceleration and deceleration of the angular velocity of the optical storage carrier.

### BACKGROUND OF INVENTION

1. Field of the Invention

The present invention relates to a recordable compact disk drive, and more particularly, to a compact disk drive with multi-stage linear velocities and different recording speeds and recording powers for each stage.

2. Description of the Prior Art

Optical storage carrier drives have been extensively used as peripheral access devices in computers. The performance of an optical storage carrier drive is often based on a recording data rate, access time, and power consumption. Nowadays, optical storage carrierdrives frequently make use of a Constant Linear Velocity (CLV) controlling method to control the rotational speed of the spindle motor in the optical storage carrier.

Please refer to FIG. 1. FIG. 1 is a diagram of a prior art CLV controlling method. A typical optical storage carrier has a spiral track upon which a plurality of data units are arranged. On the left of the horizontal axis of FIG. 1 is a data unit d₁ nearest a central portion (i.e., hub) of the optical storage carrier, and on the right of the horizontal axis of FIG. 1 is a data unit d₂ farthest from the central portion of the optical storage carrier. As shown in FIG. 1, a prior art CLV controlling method controls the rotational speed of the optical storage carrier so that data units on different positions on the spiral track pass by the read/write head of the optical storage carrier drive with equal speeds i.e. the “linear velocity” of each data unit past the read/write head is constant. Consequently, when reading the data unit d₁ nearest the center portion of the optical storage carrier, the rotational speed W₁ of the optical storage carrier is faster, and when reading the data unit d₂ farthest from the center portion of the optical storage carrier, the rotational speed W₂ of the optical storage carrier is slower.

However, the controlling method can result in high power consumption. When performing a read/write operation, the read/write head must often jump between data units at different positions on the optical storage carrier. The spindle motor must therefore continuously decelerate and accelerate to maintain a constant linear velocity for these data units. For instance, if the read/write head is required to continually access data from the data unit d₁ to the data unit d₂, the angular velocity of the spindle motor must decelerate from W₁ to W₂. Conversely, if the read/write head is required to access data from the data unit d₂ to the data unit d₁, the angular velocity of the spindle motor must accelerate to W₁ from W₂. This acceleration and deceleration of the spindle motor often results in relatively large power consumption, and may lead to the optical storage carrier drive being both inefficient and slower in terms of access speed. This is especially true in 16X CD-ROMs and above, where deceleration and acceleration jolts the CD-ROM and causes the CD-ROM to be noisy, and can even be potentially damaging to the computer system.

A possible solution to the problem involves using a constant angular velocity (CAV) controlling method. Under the CAV method, the angular velocity of the optical storage carrier is constant, and the linear velocity of data units with respect to the read/write head thus varies with the positions of the data units. However, although the controlling method helps to avoid the above-mentioned problems associated with deceleration and acceleration, it requires on-the-fly optical power calibration to compensate for the changing linear velocities. This requires a more complex system design. A great drawback to this is that the related control systems, such as control chip sets, currently have not yet reached a point of sufficient reliability and sufficiency.

### Summary of Invention

It is therefore a primary objective of the present invention to provide an optical storage carrier drive with multi-stage linear velocities and an access controlling method to solve the above-mentioned problems.

The claimed invention provides an access controlling method for use in an optical storage carrier drive. The optical storage carrier drive comprises a rotative mechanism for rotating an optical storage carrier, and a data access device for recording data to a spiral track on the optical storage carrier, or for reading data from the spiral track of the optical storage carrier. The spiral track comprises a plurality of data units. The speed of data units passing by the data access device is termed the linear velocity. Using a look-up table, the data units on the spiral track are divided into at least two sequentially arranged data blocks, and a linear velocity speed of each data block is stored in the look-up table. The linear velocity of a data block varies from the linear velocity of another data block. Access to a data unit is determined by which data block the data unit located to, and the look-up table is used to determine the linear velocity corresponding to the data block. The data access device is moved to the data unit, and the rotative mechanism is controlled so that the data block that the data unit located to maintains the appropriate linear velocity. The data access device then records or reads data from the data unit.

In more detailed, the claimed invention discloses an access controlling method used in the optical storage carrier drive. The optical storage carrier drive comprises: a rotative mechanism for rotating the optical storage carrier, a data access device for recording data to a track formed on the optical storage carrier, and a look-up table. The look-up table storing a linear velocity corresponding to each data block.

The track formed on the optical storage carrier comprises a plurality of data units, each data unit capable of passing by the data access device for recording data thereon, and the plurality of data units is sequentially divided into a first data block and a second data block.

The method comprises steps of: (a) selecting the targeted data unit to be accessed from the plurality of data units; (b) determining the targeted data block where the targeted data unit located from the first and the second data blocks; (c) determining the targeted linear velocity corresponding to the targeted data block through reading the look-up table; (d) controlling the rotative mechanism rotated in the targeted linear velocity; and (e)recording data to the targeted data unit by moving the data access device to the targeted data unit.

It is an advantage of the claimed invention that the access controlling method divides the data unit into at least two sequentially arranged data blocks and gives each data block different linear velocities to reduce the number of decelerating and accelerating operations required by the spindle motor.

These and other objectives and advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a diagram of a prior art constant linear velocity controlling method.

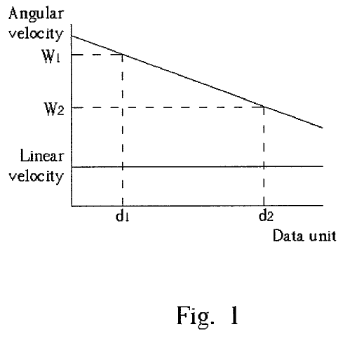

FIG. 2 is a diagram of a present invention optical storage carrier drive.

FIG. 3 is a diagram of an optical storage carrier shown in FIG. 2.

FIG. 4 is a diagram of a look-up table stored in a control device shown in Fig.2.

FIG. 5 is a diagram of a present invention controlling method of multi-stage linear velocities.

FIG. 6 is a flow chart of the present invention controlling method.

FIG. 7 is a result diagram of an experiment of the present invention controlling method.

FIG. 8 is a contrast diagram of the present invention controlling method with the prior art constant linear velocity method.

### DETAILED DESCRIPTION

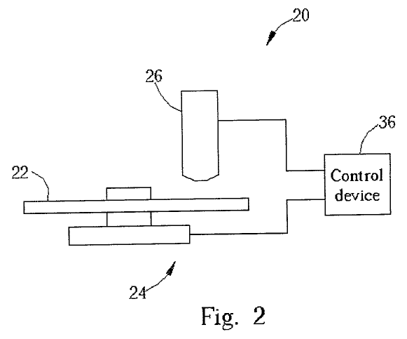

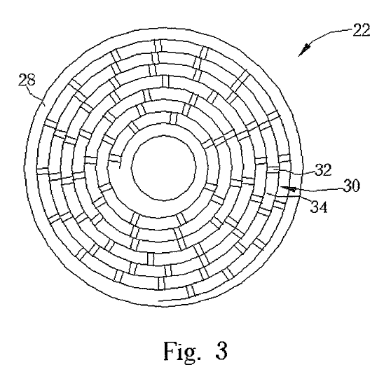

Please refer to FIG. 2 and FIG. 3. FIG. 2 is a diagram of a present invention optical storage carrier drive 20. FIG. 3 is a diagram of an optical storage carrier 22 shown in FIG. 2. The optical storage carrier drive 20 comprises a rotative mechanism 24 for rotating an optical storage carrier 22, a data access device 26 functioning as an optical read/write head for reading data from a spiral track 28 on the optical storage carrier 22, and for recording data to the spiral track 28. The optical storage carrier drive 20 also has a control device 36 for controlling the operations of the optical storage carrier drive 20.

As shown in FIG. 3, the spiral track 28 of the optical storage carrier 22 comprises a plurality of data units 30, with a starting position of each data unit 30 having a logic block address (LBA) 32 for indexing a position of the data unit 30 on the spiral track 28, and a data area 34 for storing optical data. A speed of the data units 30 on the spiral track 28 of the optical storage carrier 22 passing by the data access device 26 shown in FIG. 2 is defined as the linear velocity.

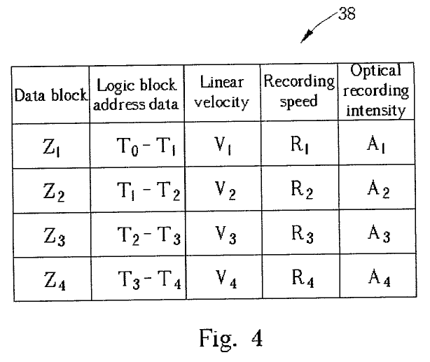

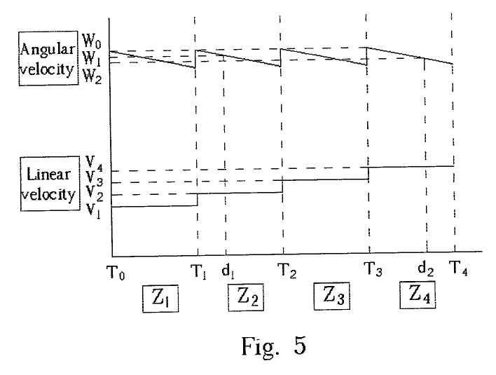

Please refer to FIG. 4 and FIG. 5. FIG. 4 is a diagram of a look-up table 38 stored in the control device 36 of FIG. 2. FIG. 5 is a diagram of the present invention multi-stage linear velocities controlling method. As shown in FIG. 4, the control device 36 stores the look-up table 38 to divide the data units 30 on the spiral track 28 into four sequentially arranged data blocks Z₁,Z₂,Z₃,Z₄. In the optical storage carrier 22, the data block Z4 is positioned farther away from the center of the optical storage carrier 22 than the data block Z₃, the data block Z₃ is positioned farther away from the center of the optical storage carrier 22 than the data block Z₂, and the data block Z₂ is positioned farther away from the center of the optical storage carrier 22 than the data block Z₁. Each data block has corresponding valid logic block address range (T₀˜T₁,T₁˜T₂,T₂˜T₃,T₃˜T₄), and a corresponding linear velocity (V₁,V₂,V₃,V₄) for each set of logic block address data, all of which is stored in the look-up table 38. The linear velocity of each data block is different from the linear velocity of the other data blocks, i.e. V₁, V₂, V₃ and V₄ are different.

When the control device 36 tries to reads or records data from/to a targeted data unit selected from the plurality of data units, the control device 36 firstly uses the look-up table 38 to determine the targeted data block (Z₁, Z₂, Z₃, or Z₄) where the targeted data unit logic block address is located, and determine the linear velocity corresponding to the targeted data block. The control device 36 then moves the data access device 26 to the targeted data unit, and controls the rotative mechanism 24 rotated with the linear velocity corresponding to the targeted data block; so that the targeted data unit is accessed by passing the data access device 26 with the linear velocity corresponding to the targeted data block.

As shown in FIG. 5, on the spiral track 28, the linear velocities of the data units 30 within the same data block are the same. The rotative mechanism 24 of the optical storage carrier drive 20 comprises a rotational speed controller for controlling the rotational speed of the optical storage carrier 22 so that when the data access device 26 records to or reads from the targeted data block, the linear velocity of the targeted data block passing the data access device 26 maintains the linear velocity corresponding to the data block.

As shown in FIG. 5, when a data block is positioned farther away from the center of the optical storage carrier 22 than another data block, the linear velocity corresponding to the outside data block is higher than the linear velocity corresponding to the inside data block. For example, in the preferred embodiment, V₄>V₃>V₂>V₁. The angular velocity of the starting position T₀, T₁, T₂, T₃ of each data block is called a starting angular velocity of the data block, and the starting angular velocities of each data block are approximately equal, as shown by W₀ in FIG. 5.

If the data access device 26 firstly accesses the data unit d₁ and then directly jumped to the data unit d₂, the angular velocity of the spindle motor needs only to decelerate to W₂ from W₁. Similarly, if the data access device 26 firstly accesses the data unit d₂ and then directly jumped to the data unit d₁, the angular velocity of the spindle motor needs only to accelerate to W₁ from W₂. Obviously, in the present invention controlling method, the range of accelerating and decelerating of the spindle motor is much smaller than the prior art controlling method of constant linear velocity. Therefore, the associated power consumption and jolting problems are reduced as well.

The amount of data recorded to the optical storage carrier within per time unit is defined as a “recording speed” of the data access device 26 R₁, R₂, R₃, R₄. The recording speed needs to be synchronized in time with the linear velocity. When the linear velocity of a data block is higher, the corresponding recording speed should be higher, and when the linear velocity of a data block is lower, the corresponding recording speed should be lower. As shown in FIG. 4, in the preferred embodiment, each data block has a corresponding recording speed stored in the look-up table 38, and the recording speed of each data block is different from the recording speed of the other data blocks. When the data access device 26 records data to the targeted data unit, the data access device 26 records data to the targeted data unit according to the recording speed corresponding to the targeted data block. The data access device 26 uses a timing signal to control the recording speed of data. The timing signal is controlled by the data access device 26. When the frequency of the timing signal is higher, the recording speed is higher, and when the frequency of the timing signal is lower, the recording speed is lower.

The laser light intensity used to record data by the data access device 26 is called an optical recording power. The optical recording power must also work in conjunction with the linear velocity at the time of recording. When the linear velocity of a data block is higher, the corresponding optical recording power should be higher, and when the linear velocity of a data block is lower, the corresponding optical recording power should be lower. As shown in FIG. 4, in the preferred embodiment, each data block has a corresponding optical recording power A₁, A₂, A₃, A₄ listed in the look-up table 38, and the optical recording power of each data block is different from the optical recording powers of the other data blocks. When the data access device 26 records data to a data block, the data access device 26 records data to the data block according to the optical recording power corresponding to the data block.

The number of data units 30 in each above-mentioned data block is approximately equal. A division position Tᵢ of each data block is determined according to the following formula:

T=π(R²−R²)/(V q)+T i=1, 2, . . . ,n Eq.(1)

wherein

R₀=(N₁V₁)/_{ω0} Eq.(2)

Rᵢ=(Nᵢ₊₁V₁)/₀ Eq.(3)

wherein Tᵢ is the starting logic block address of the i^{th} data block; T₀ is the starting logic block address of the optical storage carrier; Rᵢ is a radial distance from Tᵢ to the center of the optical storage carrier; R₀ is a radial distance from T₀ to the center of the optical storage carrier; Vₐ is a constant linear velocity of 1.3 m/s; q is a track pitch of the optical storage carrier, which is approximately 1.6 μm; Vᵢ is a linear velocity of the i^{th} data block; Nᵢ is a speed times factor of the i^{th} data block; and ω₀ is the above-mentioned starting angular velocity. From the above, the number of data units 30 in each data block is approximately equal. Of course, the preferred embodiment of the present invention is not limited to this configuration, and data blocks having different number of data units 30 are also possible.

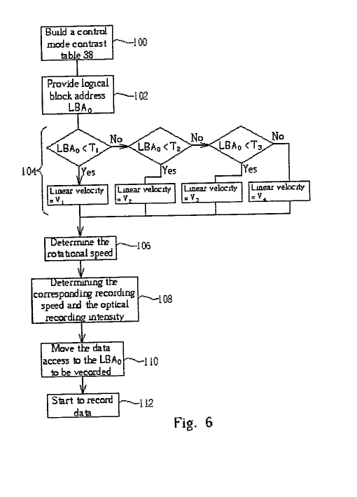

Please refer to FIG. 6 of a flow chart of the present invention controlling method. The present invention controlling method comprises:

Step 100: Build the look-up table 38.

Step 102: select a logic block address LBA₀ of the targeted data unit to be accessed.

Step 104: According to the look-up table 38, determine the targeted data block (one of Z₁˜Z₄) where the targeted data unit is located (i.e., which of the valid address range T₀˜T₁, T₁˜T₂ . . . includes the logic block address LBA₀), and the targeted linear velocity (one of V₁˜V₄) corresponding to the targeted data block.

Step 106: Determine the rotational speed of the rotative mechanism 24 based on the targeted linear velocity.

Step 108: If recording, utilize the look-up table 38 to determine the corresponding recording speed and the optical recording power.

Step 110: Move the data access device 26 to the data unit to be accessed. Control the rotative mechanism 24 so that the data block maintains the targeted linear velocity corresponding to the data unit.

Step 112: Begin to record to or read from the data unit to be accessed.

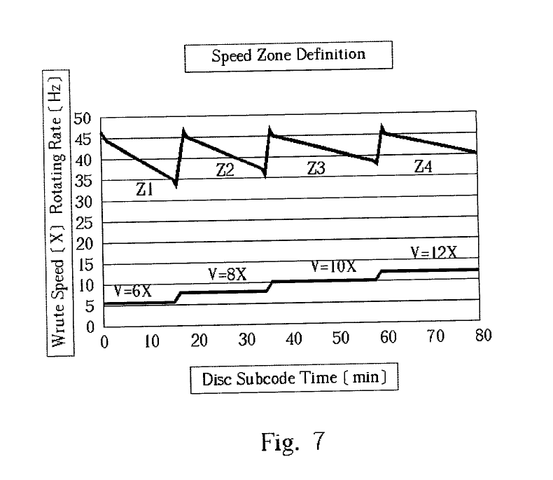

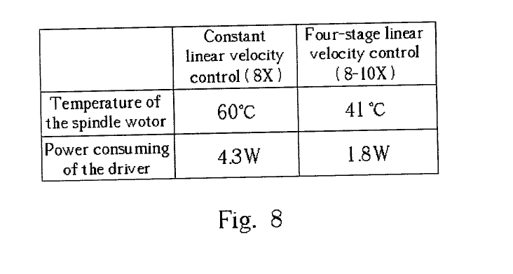

Please refer to FIG. 7 and FIG. 8. FIG. 7 is a result diagram of an experiment of the present invention controlling method. FIG. 8 is a diagram contrasting the present invention controlling method with the prior art constant linear velocity controlling method. As shown in FIG. 7, the linear velocities of the four data blocks Z₁, Z₂, Z₃, Z₄ are respectively set to 6X, 8X, 10X, and 12X. As shown in FIG. 8, in contrast to the constant linear velocity controlling method of the prior art, the present invention controlling method reduces the temperature of the spindle motor (from 60° to 41°). For the motor driver, the present invention controlling method consumes less power (from 4.3 watts to 1.8 watts).

By way of example, the above embodiment divides the data units 30 on the optical storage carrier 22 into four data blocks Z₁, Z₂, Z₃, Z₄. However, as long as there are more than two data blocks and corresponding linear velocities, the objectives of the present invention will be met.

In the contrast to the prior art controlling method, the present invention controlling method divides the plurality of data units 30 into at least two sequentially arranged data blocks, and assigns to each data block a different linear velocity. In this manner, the angular velocity of the optical storage carrier 22 is limited to a smaller range. When the data access device 26 is required to access data in different positions, the degree of accelerating and decelerating of the rotative mechanism 24 is reduced substantially. Therefore, power consumption, system temperature, and mechanism jolting are all reduced.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An access controlling method used in an optical storage carrier drive, the optical storage carrier drive comprising a rotative mechanism for rotating an optical storage carrier, a data access device for recording data to a track formed on the optical storage carrier, and a look-up table, the track comprising a plurality of data units, each data unit capable of passing by the data access device for recording data thereon, the plurality of data units being sequentially divided into a first data block and a second data block, the look-up table storing a linear velocity corresponding to each data block, the method comprising steps of:
selecting a targeted data unit from the plurality of data units;
determining a targeted data block where the targeted data unit is located, the targeted data block corresponding to one of the first and the second data blocks;
determining a targeted linear velocity corresponding to the targeted data block through reading the look-up table;
controlling the rotative mechanism rotated in the targeted linear velocity; and
recording data to the targeted data unit by moving the data access device to the targeted data unit.

2. The controlling method of claim 1 wherein the number of data units in each data block is approximately equal.

3. The controlling method of claim 1 wherein the first data block is positioned farther away from a center of the storage carrier than the second data block, the linear velocity corresponding to the first data block being higher than the linear velocity corresponding to the second data block.

4. The controlling method of claim 1 wherein a starting angular velocity of each data block is approximately equal, the starting angular velocity being an angular velocity corresponding to a starting position of each data block.

5. The controlling method of claim 1 wherein the look-up table further stores an optical recording power for each data block, the data access device recording data into the first data block according to the optical recording power corresponding to the first data block.

6. The controlling method of claim 1 wherein the look-up table further stores a recording speed for each data block; and when the data access device records data into the first data block, the data access device records data into the data block according to the recording speed corresponding to the first data block.

7. The controlling method of claim 6 wherein the data access device controls the recording speed according to a timing signal.

8. The controlling method of claim 1 wherein the rotative mechanism of the optical storage carrier drive comprises a rotational speed controller capable of maintaining a constant linear velocity (CLV) of the rotative speed of the rotative mechanism, so that when the data access device records data from the first data block, the linear velocity of the data block passing by the data access device remains constant.

9. The controlling method of claim 1 wherein each data unit comprises an addressing index for indexing the data units on the track, and the look-up table further stores a valid address range corresponding to each data block, the controlling method searching the addressing index of the targeted data unit from the valid address range in order to determine the targeted data block.

10. An optical storage carrier drive for recording data to a track formed on an optical storage carrier, the track comprising a plurality of data units, and the plurality of data units being divided into a first data block and a second data block, the carrier drive comprising:
a rotative mechanism for rotating the optical storage carrier;
a data access device for recording data to the track of the optical storage carrier, the data units capable of passing by the data access device at a linear velocity; and
a control device for controlling operations of the optical storage carrier drive, the control device having a look-up table which stores a corresponding linear velocity corresponding to each data unit,
wherein when the control device records data to a targeted data unit, the control device utilizes the look-up table to determine a targeted data block where the targeted data unit is located, controls the rotative mechanism rotated with the linear velocity corresponding to the targeted data block, and then records data into the targeted data unit by moving the data access device to the targeted data unit.

11. The optical storage carrier drive of claim 10 wherein the number of data units located in each data block is approximately equal.

12. The optical storage carrier drive of claim 10 wherein the first data block is positioned farther away from a center of the optical storage carrier than the second data block, the linear velocity corresponding to the first data block being larger than the linear velocity corresponding to the second data block.

13. The optical storage carrier drive of claim 12 wherein a starting angular velocity of each data block is approximately equal, the starting angular velocity of a data block being an angular velocity corresponding to a starting position of each data block.

14. The optical storage carrier drive of claim 10 wherein the look-up table further stores an optical recording power for each data block, the data access device recording data into the first data block according to the optical recording power corresponding to the first data block.

15. The optical storage carrier drive of claim 10 wherein the look-up table further stores a recording speed for each data block; and when the data access device records data into the first data block, the data access device records data into the data block according to the recording speed corresponding to the first data block.

16. The optical storage carrier drive of claim 15 wherein the control device controls the recording speed according to a timing signal.

17. The optical storage carrier drive of claim 10 wherein the rotative mechanism comprises a rotational speed controller capable of maintaining a constant linear velocity (CLV) of the rotative speed of the rotative mechanism, so that when the data access device records data from the first data block, the linear velocity of the data block passing by the data access device remains constant.

18. The optical storage carrier drive of claim 10 wherein each data unit comprises an addressing index for indexing the data units on the track, and the look-up table further stores a valid address range corresponding to each data block, the controlling method searching the addressing index of the targeted data unit from the valid address range in order to determine the targeted data block.
